(19) United States
(12) Patent Application Publication
(10) Pub. No.: US 2013/0282739 A1
(43) Pub. Date: Oct. 24, 2013

(54) GENERATING A LOG PARSER BY AUTOMATICALLY IDENTIFYING REGULAR EXPRESSIONS MATCHING A SAMPLE LOG

(71) Applicants: Brian M. Anderson, Dunwoody, GA (US); Michael A. Hughes, Liburn, GA (US); HuyAnh D. Ngo, Sterling Heights, MI (US); Patrick A. Spizzo, Oak Brook, IL (US)

(72) Inventors: Brian M. Anderson, Dunwoody, GA (US); Michael A. Hughes, Liburn, GA (US); HuyAnh D. Ngo, Sterling Heights, MI (US); Patrick A. Spizzo, Oak Brook, IL (US)

(73) Assignee: INTERNATIONAL BUSINESS MACHINES CORPORATION, Armonk, NY (US)

(21) Appl. No.: 13/449,531

(22) Filed: Apr. 18, 2012

(51) Int. Cl. G06F 17/30

(52) U.S. Cl. 707/755; 707/E17.009

(57) ABSTRACT

An approach is presented for generating a log parser. Regular expressions are received and stored in a crowd-sourced data repository. An instruction is received to create a log parser based on a sample log. The sample log is received. Matches are identified between strings of characters included in the received sample log and regular expressions included in the stored regular expressions. Each match indicates a stored regular expression is capable of parsing a string included in the sample log. Based on the identified matches, the log parser is generated so as to include the regular expressions that match the strings included in the sample log.

### TECHNICAL FIELD

The present invention relates to a data processing method and system for managing computer data logs, and more particularly to a technique for generating a log parser.

### BACKGROUND

A log parser is a set of regular expressions that are used to parse each line of a particular type of log file (i.e., a computer file that includes a computer data log). The log file may include, for example, a record of system activity events (e.g., login, login failed, logout, and password changed). In currently used techniques for generating log parsers, a user manually writes regular expressions for a log parser using a known interface. The known interface applies each manually written regular expression to a log file and presents information that allows the user to determine whether or not the regular expression is effective.

### SUMMARY

In first embodiments, the present invention provides a method of generating a log parser. The method includes a computer receiving regular expressions and storing the regular expressions in a crowd-sourced data repository. The method further includes, subsequent to receiving and storing the regular expressions, the computer receiving an instruction to create a log parser based on a sample log. The method further includes the computer receiving the sample log. The method further includes, based on the stored regular expressions and the received sample log, the computer identifying matches between a plurality of strings of characters included in the received sample log and a plurality of regular expressions included in the stored regular expressions. Each match indicates a regular expression included in the plurality of regular expressions is capable of parsing a respective string included in the plurality of strings. The method further includes, based on the identified matches, the computer generating the log parser as including the plurality of regular expressions that match the plurality of strings included in the sample log.

In second embodiments, the present invention provides a computer system including a central processing unit (CPU), a memory coupled to the CPU, and a computer-readable, tangible storage device coupled to the CPU. The storage device contains instructions that, when carried out by the CPU via the memory, implement a method of generating a log parser. The method includes the computer system receiving regular expressions and storing the regular expressions in a crowd-sourced data repository. The method further includes, subsequent to receiving and storing the regular expressions, the computer system receiving an instruction to create a log parser based on a sample log. The method further includes the computer system receiving the sample log. The method further includes, based on the stored regular expressions and the received sample log, the computer system identifying matches between a plurality of strings of characters included in the received sample log and a plurality of regular expressions included in the stored regular expressions. Each match indicates a regular expression included in the plurality of regular expressions is capable of parsing a respective string included in the plurality of strings. The method further includes, based on the identified matches, the computer system generating the log parser as including the plurality of regular expressions that match the plurality of strings included in the sample log.

In third embodiments, the present invention provides a computer program product including a computer-readable, tangible storage device and computer-readable program instructions stored in the computer-readable, tangible storage device. The computer-readable program instructions, when carried out by a central processing unit (CPU) of a computer system, implement a method of generating a custom log parser. The method includes the computer system receiving regular expressions and storing the regular expressions in a crowd-sourced data repository. The method further includes, subsequent to receiving and storing the regular expressions, the computer system receiving an instruction to create a log parser based on a sample log. The method further includes the computer system receiving the sample log. The method further includes, based on the stored regular expressions and the received sample log, the computer system identifying matches between a plurality of strings of characters included in the received sample log and a plurality of regular expressions included in the stored regular expressions, each match indicating a regular expression included in the plurality of regular expressions is capable of parsing a respective string included in the plurality of strings. The method further includes, based on the identified matches, the computer system generating the log parser as including the plurality of regular expressions that match the plurality of strings included in the sample log.

In fourth embodiments, the present invention provides a process for supporting computing infrastructure. The process includes a first computer system providing at least one support service for at least one of creating, integrating, hosting, maintaining, and deploying computer-readable code in a second computer system. The computer-readable code contains instructions. The instructions, when carried out by a processor of the second computer system, implement a method of generating a log parser. The method includes the second computer system receiving regular expressions and storing the regular expressions in a crowd-sourced data repository. The method further includes, subsequent to receiving and storing the regular expressions, the second computer system receiving an instruction to create a log parser based on a sample log. The method further includes the second computer system receiving the sample log. The method further includes, based on the stored regular expressions and the received sample log, the second computer system identifying matches between a plurality of strings of characters included in the received sample log and a plurality of regular expressions included in the stored regular expressions, each match indicating a regular expression included in the plurality of regular expressions is capable of parsing a respective string included in the plurality of strings. The method further includes, based on the identified matches, the second computer system generating the log parser as including the plurality of regular expressions that match the plurality of strings included in the sample log.

Embodiments of the present invention saves the user time by automating the generation of log parsers based on a sample log. An embodiment of the present invention automatically queries regular expressions from a database and attempts to match the regular expressions against a sample log to determine a log parser. An embodiment of the present invention leverages user-generated (i.e., crowd sourced) regular expressions to populate a regular expression database that is subsequently queried to match the regular expressions in the database against a sample log, thereby determining a log parser.

### BRIEF DESCRIPTION OF THE SEVERAL VIEWS OF THE DRAWINGS

FIG. 1 depicts a block diagram of a system for generating a custom log parser, in accordance with embodiments of the present invention.

FIGS. 2A-2B depict a flowchart of a process of generating a custom log parser, where the process is implemented in the system of FIG. 1, in accordance with embodiments of the present invention.

FIG. 3 is a block diagram of a computer system that is included in the system of FIG. 1 and that implements the process of FIGS. 2A-2B, in accordance with embodiments of the present invention.

### DETAILED DESCRIPTION

### Overview

Embodiments of the present invention generate a log parser based on a sample log by automatically querying a database of regular expressions to determine potential matches between the regular expressions and the sample log. An embodiment of the present invention employs crowd sourcing techniques to populate a database of regular expressions with new entries of user-generated regular expressions. The new entries of user-generated regular expressions are defined for data in a log sample that is identified as not being parsed by previously stored regular expressions. The crowd sourcing techniques allow a repository of log parsers to be built up to recognize and support a greater number of logs from platforms and applications that are currently unrecognized and unsupported. Herein, a regular expression is also referred to as a regex.

### System for Generating a Custom Log Parser

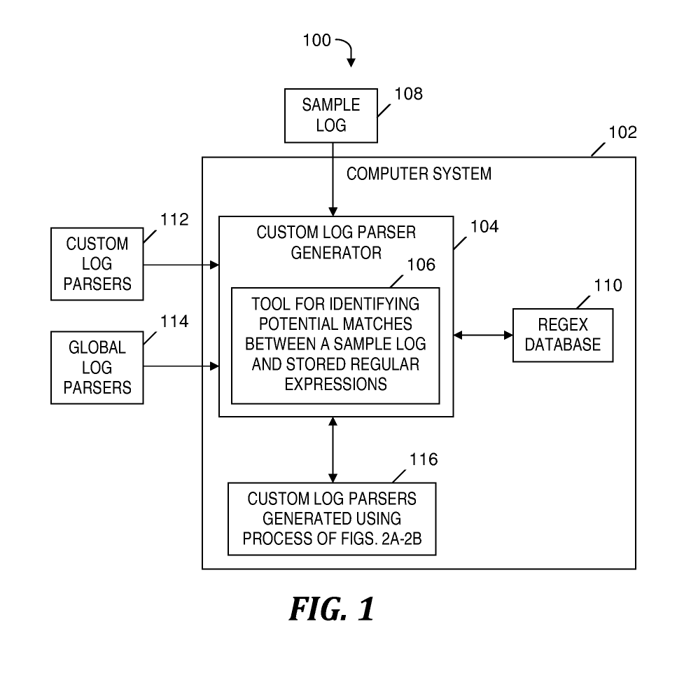

FIG. 1 depicts a block diagram of a system for generating a custom log parser, in accordance with embodiments of the present invention. System 100 includes a computer system 102 that runs a software-based custom log parser generator 104, which includes a software tool 106 for identifying potential matches between elements (i.e., character strings) of a sample log 108 and regular expressions stored in regular expression database 110 (also referred to herein as regex database 110). Sample log 108 may be a computer log file, such as a system activity event log file. As used herein, a “potential match” identified by tool 106 is also simply referred to as a “match.”

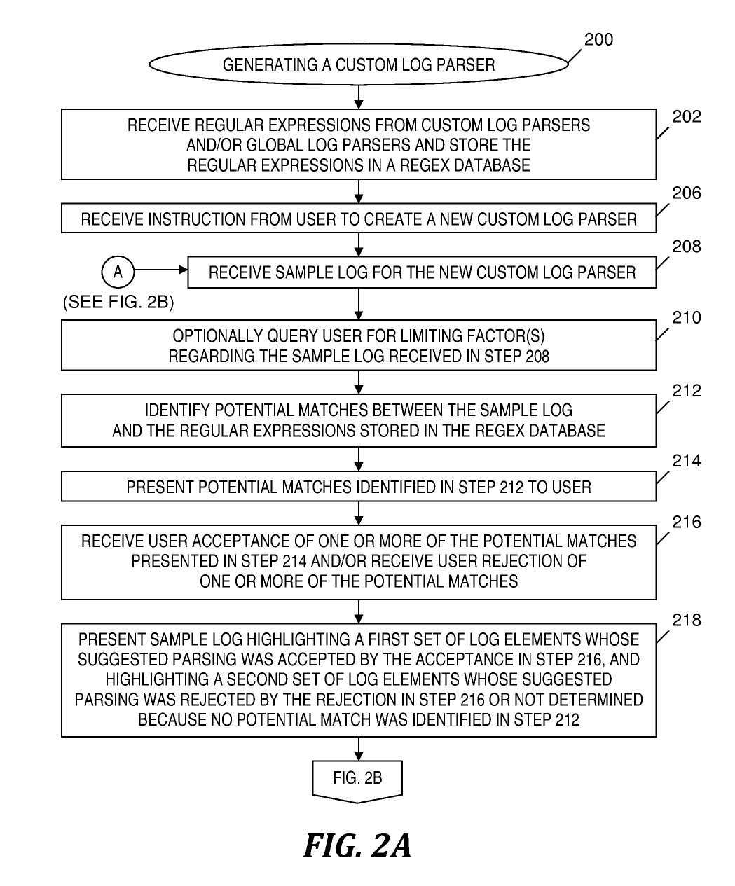

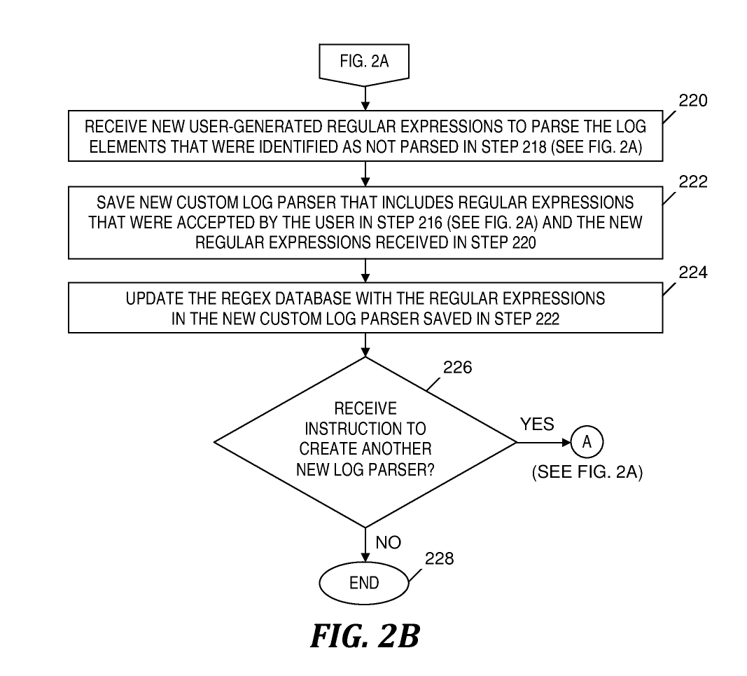

The regex database 110 may include regular expressions included in one or more manually generated custom log parsers 112 (i.e., log parsers generated by one or more methods other than the process of FIGS. 2A-2B), one or more global log parsers 114 that support predefined applications and/or computer platforms, and/or one or more custom log parsers 116 generated by previous performances of the process of FIGS. 2A-2B. As one example, global log parsers 114 are engineer-generated for Managed Security Services (MSS) which monitor and manage information asset security technologies. MSS is offered by International Business Machines Corporation located in Armonk, N.Y. As one example, custom log parsers 112 are generated by customers or other users who utilize known, manual log parser generation techniques, and parse logs provided by applications and/or computer platforms that are not supported by global log parsers 114.

Tool 106 identifies matches between elements of sample log 108 and regular expressions included in regex database 110. Each identified match indicates that a regular expression included in regex database 110 is potentially capable of correctly parsing a corresponding element of sample log 108. Tool 106 may identify one or more matches for any single element of sample log 108; therefore, one element of sample log 108 may be matched to one or more regular expressions included regex database 110.

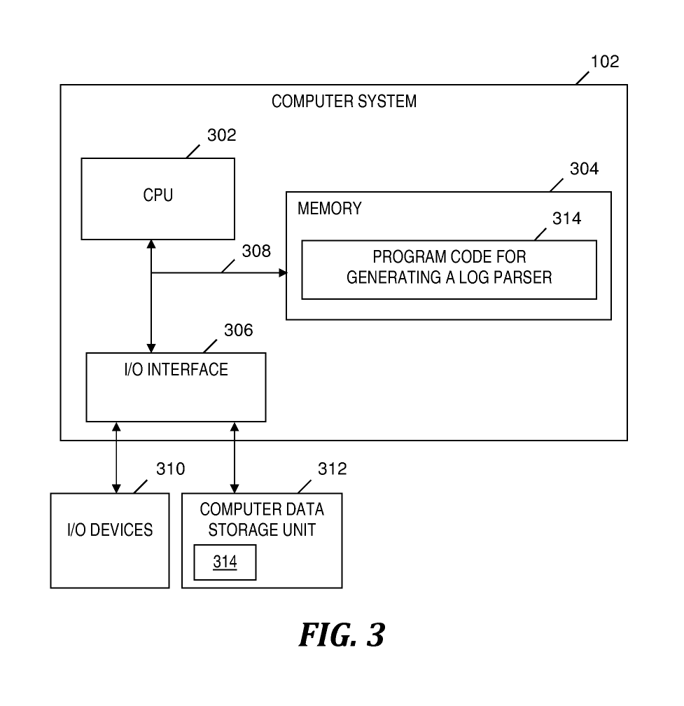

Based on the matches identified by tool 106, custom log parser generator 104 generates a custom log parser, which is stored in custom log parsers 116. The functionality of the components shown in FIG. 1 is described below in more detail in the discussion of FIGS. 2A-2B and FIG. 3.

Although components 108, 112 and 114 of system 100 are shown in FIG. 1 as being exterior to computer system 102, any combination of components 108, 112 and 114 may be included in computer system 102 in an alternate embodiment. Although components 110 and 116 of system 100 are shown in FIG. 1 as being included in computer system 102, a combination of components 110 and 116 may be exterior to computer system 102 in an alternate embodiment.

### Process for Generating a Custom Log Parser

FIGS. 2A-2B depict a flowchart of a process of generating a custom log parser, where the process is implemented in the system of FIG. 1, in accordance with embodiments of the present invention. The process of generating a custom log parser starts at step 200. In step 202, custom log parser generator 104 (see FIG. 1) receives regular expressions from one or more custom log parsers 112 (see FIG. 1) and/or one or more global log parsers 114 (see FIG. 1). Following the receipt of the regular expressions in step 202, custom log parser generator 104 (see FIG. 1) stores regular expressions received in step 202 to regex database 110 (see FIG. 1).

In one embodiment, each regular expression is stored in step 202 along with indicator(s) of the computer application type and/or computer platform type that is associated with the regular expression. That is, regex database 110 (see FIG. 1) associates each regular expression with the application type and/or platform type that provides logs that can be parsed by a log parser that includes the regular expression.

In one embodiment, regex database 110 (see FIG. 1) stores at least one data sample for each regular expression stored in regex database 110 (see FIG. 1).

In step 206, computer system 102 (see FIG. 1) receives an instruction from a user to create a new custom log parser. Custom log parser generator 104 (see FIG. 1) initiates the creation of the new custom log parser.

In step 208, custom log parser generator 104 (see FIG. 1) receives sample log 108 (see FIG. 1), which is a basis for the new custom log parser being created. In one embodiment, computer system 102 (see FIG. 1) scans the received sample log 108 (see FIG. 1) in step 208 to identify sample log 108 (see FIG. 1) by its application type and/or platform type.

In step 210, custom log parser generator 104 (see FIG. 1) optionally queries the user for one or more limiting factors regarding the sample log received in step 208. The limiting factor(s) that may be received by custom log parser generator 104 (see FIG. 1) as a result of the optional query in step 210 allow the filtering out of one or more of the regular expressions in regex database 110 (see FIG. 1) that do not satisfy the limiting factor(s). Because regular expression(s) in regex database 110 (see FIG. 1) may be filtered out, only a subset of the regular expressions in regex database 110 are processed, thereby improving the speed and accuracy of the identification of potential matches described below relative to step 212.

In step 212, custom log parser generator 104 (see FIG. 1) identifies potential matches between elements (i.e., strings) in sample log 108 (see FIG. 1) and the regular expressions in regex database 110 (see FIG. 1). A potential match identified in step 212 between an element in sample log 108 (see FIG. 1) and a regular expression in regex database 110 (see FIG. 1) indicates that the element may be parsed by the regular expression matched to the element. The potential matches identified in step 212 may include matches of one element of sample log 108 (see FIG. 1) to one or more regular expressions included in regex database 110 (see FIG. 1). In one embodiment, the potential matches identified in step 212 are based on the application and/or platform type identified in step 208.

If the result of step 210 is a subset of the regular expressions in regex database 110 (see FIG. 1) that satisfy the limiting factor(s), then in step 212, custom log parser generator 104 (see FIG. 1) identifies potential matches between elements in sample log 108 (see FIG. 1) and the aforementioned subset of regular expressions in regex database 110 (see FIG. 1).

In step 214, custom log parser generator 104 (see FIG. 1) presents the potential matches identified in step 212 to a user of computer system 102 (see FIG. 1) or to a user of another computer system. For example, custom log parser generator 104 (see FIG. 1) initiates a display of potential matches identified in step 212 on (1) a display device coupled to computer system 102 for viewing by a user of computer system 102; or (2) on another display device coupled to another computer system for viewing by a user of the other computer system. The identified potential matches are presented in step 214 to provide suggestions of regular expressions that are capable of parsing elements of sample log 108 (see FIG. 1), and that may potentially be added to the new custom log parser being created.

In one example, step 214 includes custom log parser generator 104 (see FIG. 1) initiating a display that indicates (1) which strings in sample log 108 (see FIG. 1) were matched by the potential matches identified in step 212 and (2) the positions in the sample log 108 (see FIG. 1) at which the potential matches were identified in step 212.

In step 216, based on the potential matches presented in step 214, custom log parser generator 104 (see FIG. 1) receives an acceptance of a first set of one or more potential matches included in the potential matches presented in step 214, which match element(s) of sample log 108 (see FIG. 1) to respective regular expression(s) included in regex database 110 (see FIG. 1). Receiving an acceptance from a user of a potential match between an element of sample log 108 (see FIG. 1) and a regular expression included in regex database 110 (see FIG. 1) indicates that the user is accepting the suggestion to include the regular expression in the new custom log parser being created and to use the regular expression to parse the element of sample log 108 (see FIG. 1).

Step 216 may also include, based on the potential matches presented in step 214, custom log parser generator 104 (see FIG. 1) receiving a rejection of a second set of one or more potential matches included in the potential matches presented in step 214, which match element(s) of sample log 108 (see FIG. 1) to respective regular expression(s) included in regex database 110 (see FIG. 1). Receiving a rejection from a user of a potential match between an element of sample log 108 (see FIG. 1) and a regular expression included in regex database 110 (see FIG. 1) indicates that the user is rejecting the suggestion to include the regular expression in the new custom log parser being created and rejecting the use of the regular expression to parse the element of sample log 108 (see FIG. 1).

In step 218, custom log parser generator 104 (see FIG. 1) determines a first set of element(s) of sample log 108 (see FIG. 1) whose suggested parsing by regular expression(s) was accepted by the potential match(es) accepted in step 216. Step 218 also includes custom log parser generator 104 (see FIG. 1) presenting (e.g., initiating a display of) sample log 108 (see FIG. 1) so that the element(s) in the aforementioned first set of element(s) of the sample log 108 (see FIG. 1) are highlighted using a first graphical attribute (e.g., highlighted by displaying the elements in a first text color).

Further, step 218 optionally includes custom log parser generator 104 (see FIG. 1) determining a second set of element(s) of sample log 108 (see FIG. 1), where each element in the second set had parsing by a respective regular expression that was either (1) rejected by every identified potential match to the element being rejected in step 216; or (2) not determined because no potential match to the element was identified in step 212. The aforementioned presentation (e.g., display on a display device) having the first set of element(s) highlighted using the first graphical attribute may also include the second set of element(s) highlighted using a second graphical attribute (i.e., an attribute different from the first graphical element; e.g., highlighted by displaying the elements in a second text color).

After step 218, the process of FIGS. 2A-2B continues with step 220 in FIG. 2B. In step 220, custom log parser generator 104 (see FIG. 1) receives new user-generated regular expression(s) to parse the element(s) in the aforementioned second set of element(s). That is, step 220 receives new user-generated regular expression(s) that parse each element for which suggested parsing was previously rejected by the rejection of potential match(es) in step 216 (see FIG. 2A) or for which suggested parsing was unable to be determined because no potential match identified in step 212 (see FIG. 2A) matched the element. A new user-generated regular expression received in step 220 may be a modification of a suggested regular expression.

In step 222, custom log parser generator 104 (see FIG. 1) saves the new custom log parser as including the regular expression(s) that were accepted by the acceptance of the potential match(es) in step 216 (see FIG. 2A) and further including the new user-generated regular expression(s) received in step 220.

In step 224, custom log parser generator 104 (see FIG. 1) updates the regex database 110 (see FIG. 1) with the regular expressions in the new custom log parser saved in step 222. In one embodiment, by repeated performances of step 224 (see the description presented below of the loop starting at the Yes branch of step 226), regular expressions are added to regex database 110 (see FIG. 1) by crowd-sourcing (i.e., the regex database 110 is crowd-sourced).

If custom log parser generator 104 (see FIG. 1) determines in step 226 that custom log parser generator 104 (see FIG. 1) receives an instruction to create another new log parser (i.e., the next new custom log parser), then the Yes branch of step 226 is followed and the process of FIGS. 2A-2B loops back to step 208 (see FIG. 2A) to receive another sample log for the next new custom log parser. Otherwise, if custom log parser generator 104 (see FIG. 1) receives an indication in step 226 that no other new log parsers are to be created, then the No branch of step 226 is followed and the process of FIGS. 2A-2B ends at step 228.

### Computer System

FIG. 3 is a block diagram of a computer system that is included in the system of FIG. 1 and that implements the process of FIGS. 2A-2B, in accordance with embodiments of the present invention. Computer system 102 generally comprises a central processing unit (CPU) 302, a memory 304, an input/output (I/O) interface 306, and a bus 308. Further, computer system 102 is coupled to I/O devices 310 and a computer data storage unit 312. CPU 302 performs computation and control functions of computer system 102, including carrying out instructions included in program code 314 to perform a method of generating a log parser, where the instructions are carried out by CPU 302 via memory 304. CPU 302 may comprise a single processing unit, or be distributed across one or more processing units in one or more locations (e.g., on a client and server). In one embodiment, program code 314 includes code for custom log parser generator 104 (see FIG. 1). In one embodiment, program code 314 includes code for the tool 106 (see FIG. 1) for identifying potential matches between sample log 108 (see FIG. 1) and regular expressions stored in regex database 110 (see FIG. 1).

Memory 304 may comprise any known computer-readable storage medium, which is described below. In one embodiment, cache memory elements of memory 304 provide temporary storage of at least some program code (e.g., program code 314) in order to reduce the number of times code must be retrieved from bulk storage while instructions of the program code are carried out. Moreover, similar to CPU 302, memory 304 may reside at a single physical location, comprising one or more types of data storage, or be distributed across a plurality of physical systems in various forms. Further, memory 304 can include data distributed across, for example, a local area network (LAN) or a wide area network (WAN).

I/O interface 306 comprises any system for exchanging information to or from an external source. I/O devices 310 comprise any known type of external device, including a display device (e.g., monitor), keyboard, mouse, printer, speakers, handheld device, facsimile, etc. Bus 308 provides a communication link between each of the components in computer system 102, and may comprise any type of transmission link, including electrical, optical, wireless, etc.

I/O interface 306 also allows computer system 102 to store information (e.g., data or program instructions such as program code 314) on and retrieve the information from computer data storage unit 312 or another computer data storage unit (not shown). Computer data storage unit 312 may comprise any known computer-readable storage medium, which is described below. For example, computer data storage unit 312 may be a non-volatile data storage device, such as a magnetic disk drive (i.e., hard disk drive) or an optical disc drive (e.g., a CD-ROM drive which receives a CD-ROM disk).

Memory 304 and/or storage unit 312 may store computer program code 314 that includes instructions that are carried out by CPU 302 via memory 304 to generate a log parser. Although FIG. 3 depicts memory 304 as including program code 314, the present invention contemplates embodiments in which memory 304 does not include all of code 314 simultaneously, but instead at one time includes only a portion of code 314.

Further, memory 304 may include other systems not shown in FIG. 3, such as an operating system (e.g., Linux®) that runs on CPU 302 and provides control of various components within and/or connected to computer system 102. Linux is a registered trademark of Linus Torvalds in the United States, other countries, or both.

Storage unit 312 and/or one or more other computer data storage units (not shown) that are coupled to computer system 102 may store regex database 110 (see FIG. 1), custom log parsers 112 (see FIG. 1), global log parsers 114 (see FIG. 1) and/or custom log parsers 116 (see FIG. 1) generated using the process of FIGS. 2A-2B.

As will be appreciated by one skilled in the art, in a first embodiment, the present invention may be a system; in a second embodiment, the present invention may be a method; and in a third embodiment, the present invention may be a computer program product. A component of an embodiment of the present invention may take the form of an entirely hardware-based component, an entirely software component (including firmware, resident software, micro-code, etc.) or a component combining software and hardware sub-components that may all generally be referred to herein as a “module”.

An embodiment of the present invention may take the form of a computer program product embodied in one or more computer-readable medium(s) (e.g., memory 304 and/or computer data storage unit 312) having computer-readable program code (e.g., program code 314) embodied or stored thereon.

Any combination of one or more computer-readable mediums (e.g., memory 304 and computer data storage unit 312) may be utilized. The computer readable medium may be a computer-readable signal medium or a computer-readable storage medium. In one embodiment, the computer-readable storage medium is a computer-readable storage device or computer-readable storage apparatus. A computer-readable storage medium may be, for example, but not limited to, an electronic, magnetic, optical, electromagnetic, infrared or semiconductor system, apparatus, device or any suitable combination of the foregoing. A non-exhaustive list of more specific examples of the computer-readable storage medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be a tangible medium that can contain or store a program (e.g., program 314) for use by or in connection with a system, apparatus, or device for carrying out instructions.

A computer readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with a system, apparatus, or device for carrying out instructions.

Program code (e.g., program code 314) embodied on a computer-readable medium may be transmitted using any appropriate medium, including but not limited to wireless, wireline, optical fiber cable, RF, etc., or any suitable combination of the foregoing.

Computer program code (e.g., program code 314) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Java and all Java-based trademarks and logos are trademarks or registered trademarks of Oracle and/or its affiliates. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 102 or another computer system (not shown) having components analogous to the components of computer system 102 included in FIG. 3. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIGS. 2A-2B) and/or block diagrams of methods, apparatus (systems) (e.g., FIG. 1 and FIG. 3), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 314). These computer program instructions may be provided to one or more hardware processors (e.g., CPU 302) of a general purpose computer, special purpose computer, or other programmable data processing apparatus to produce a machine, such that the instructions, which are carried out via the processor(s) of the computer or other programmable data processing apparatus, create means for implementing the functions/acts specified in the flowcharts and/or block diagram block or blocks.

These computer program instructions may also be stored in a computer-readable medium (e.g., memory 304 or computer data storage unit 312) that can direct a computer (e.g., computer system 102), other programmable data processing apparatus, or other devices to function in a particular manner, such that the instructions (e.g., program 314) stored in the computer-readable medium produce an article of manufacture including instructions which implement the function/act specified in the flowcharts and/or block diagram block or blocks.

The computer program instructions may also be loaded onto a computer (e.g., computer system 102), other programmable data processing apparatus, or other devices to cause a series of operational steps to be performed on the computer, other programmable apparatus, or other devices to produce a computer implemented process such that the instructions (e.g., program 314) which are carried out on the computer, other programmable apparatus, or other devices provide processes for implementing the functions/acts specified in the flowcharts and/or block diagram block or blocks.

Any of the components of an embodiment of the present invention can be deployed, managed, serviced, etc. by a service provider that offers to deploy or integrate computing infrastructure with respect to generating a log parser. Thus, an embodiment of the present invention discloses a process for supporting computer infrastructure, wherein the process comprises a first computer system providing at least one support service for at least one of integrating, hosting, maintaining and deploying computer-readable code (e.g., program code 314) in a second computer system (e.g., computer system 102) comprising one or more processors (e.g., CPU 302), wherein the processor(s) carry out instructions contained in the code causing the second computer system to generate a log parser.

In another embodiment, the invention provides a method that performs the process steps of the invention on a subscription, advertising and/or fee basis. That is, a service provider, such as a Solution Integrator, can offer to create, maintain, support, etc. a process of generating a log parser. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flowcharts in FIGS. 2A-2B and the block diagrams in FIG. 1 and FIG. 3 illustrate the architecture, functionality, and operation of possible implementations of systems, methods, and computer program products according to various embodiments of the present invention. In this regard, each block in the flowcharts or block diagrams may represent a module, segment, or portion of code (e.g., program code 314), which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of generating a log parser, the method comprising the steps of:
a computer receiving regular expressions and storing the regular expressions in a crowd-sourced data repository;
subsequent to receiving and storing the regular expressions, the computer receiving an instruction to create a log parser based on a sample log;
the computer receiving the sample log;
based on the stored regular expressions and the received sample log, the computer identifying matches between a plurality of strings of characters included in the received sample log and a plurality of regular expressions included in the stored regular expressions, each match indicating a regular expression included in the plurality of regular expressions is capable of parsing a respective string included in the plurality of strings; and
based on the identified matches, the computer generating the log parser as including the plurality of regular expressions that match the plurality of strings included in the sample log.

2. The method of claim 1, further comprising the steps of:
the computer querying the data repository to attempt to identify one or more regular expressions in the data repository capable of parsing one string included in the sample log;
in response to the step of querying the data repository, the computer determining no regular expression in the data repository is capable of parsing the one string included in the sample log; and
subsequent to the step of determining no regular expression in the data repository is capable of parsing the one string included in the sample log, the computer receiving a user input of a new regular expression capable of parsing the one string included in the sample log, wherein the step of generating the log parser includes the step of generating the log parser as further including the new regular expression.

3. The method of claim 2, further comprising the steps of:
the computer storing the new regular expression in the data repository;
the computer receiving another instruction to create another log parser based on another sample log;
the computer receiving the other sample log;
based on the stored new regular expression and the received other sample log, the computer identifying a match between another string included in the received other sample log and the stored new regular expression; and
based on the identified match and based on the new regular expression being included in the generated log parser, the computer generating the other log parser as including the new regular expression that matches the other string included in the other sample log, without requiring another user input of the new regular expression.

4. The method of claim 1, further comprising the steps of:
the computer querying the data repository;
in response to the step of querying the data repository, the computer identifying one regular expression in the data repository that potentially matches one string included in the sample log;
the computer presenting a suggestion to use the identified one regular expression to parse the one string included in the sample log;
in response to the step of presenting the suggestion, the computer receiving a first user input rejecting the suggestion;
subsequent to the step of receiving the first user input rejecting the suggestion, the computer receiving a second user input of a new regular expression capable of parsing the one string included in the sample log, wherein the step of generating the log parser includes the step of generating the log parser as further including the new regular expression.

5. The method of claim 4, further comprising the steps of:
the computer storing the new regular expression in the data repository;
the computer receiving another instruction to create another log parser based on another sample log;
the computer receiving the other sample log;
based on the stored new regular expression and the received other sample log, the computer identifying a match between another string included in the received other sample log and the stored new regular expression; and
based on the identified match and based on the new regular expression being included in the generated log parser, the computer generating the other log parser as including the new regular expression that matches the other string included in the other sample log, without requiring another user input of the new regular expression.

6. A computer system comprising:
a central processing unit (CPU);
a memory coupled to the CPU;
a computer-readable, tangible storage device coupled to the CPU, the storage device containing instructions that, when carried out by the CPU via the memory, implement a method of generating a log parser, the method comprising the steps of:
the computer system receiving regular expressions and storing the regular expressions in a crowd-sourced data repository;
subsequent to receiving and storing the regular expressions, the computer system receiving an instruction to create a log parser based on a sample log;
the computer system receiving the sample log;
based on the stored regular expressions and the received sample log, the computer system identifying matches between a plurality of strings of characters included in the received sample log and a plurality of regular expressions included in the stored regular expressions, each match indicating a regular expression included in the plurality of regular expressions is capable of parsing a respective string included in the plurality of strings; and
based on the identified matches, the computer system generating the log parser as including the plurality of regular expressions that match the plurality of strings included in the sample log.

7. The computer system of claim 6, wherein the method further comprises the steps of:
the computer system querying the data repository to attempt to identify one or more regular expressions in the data repository capable of parsing one string included in the sample log;
in response to the step of querying the data repository, the computer system determining no regular expression in the data repository is capable of parsing the one string included in the sample log; and
subsequent to the step of determining no regular expression in the data repository is capable of parsing the one string included in the sample log, the computer system receiving a user input of a new regular expression capable of parsing the one string included in the sample log, wherein the step of generating the log parser includes the step of generating the log parser as further including the new regular expression.

8. The computer system of claim 7, wherein the method further comprises the steps of:
the computer system storing the new regular expression in the data repository;
the computer system receiving another instruction to create another log parser based on another sample log;
the computer system receiving the other sample log;
based on the stored new regular expression and the received other sample log, the computer system identifying a match between another string included in the received other sample log and the stored new regular expression; and
based on the identified match and based on the new regular expression being included in the generated log parser, the computer system generating the other log parser as including the new regular expression that matches the other string included in the other sample log, without requiring another user input of the new regular expression.

9. The computer system of claim 6, wherein the method further comprises the steps of:
the computer system querying the data repository;
in response to the step of querying the data repository, the computer system identifying one regular expression in the data repository that potentially matches one string included in the sample log;
the computer system presenting a suggestion to use the identified one regular expression to parse the one string included in the sample log;
in response to the step of presenting the suggestion, the computer system receiving a first user input rejecting the suggestion;
subsequent to the step of receiving the first user input rejecting the suggestion, the computer system receiving a second user input of a new regular expression capable of parsing the one string included in the sample log, wherein the step of generating the log parser includes the step of generating the log parser as further including the new regular expression.

10. The computer system of claim 9, wherein the method further comprises the steps of:
the computer system storing the new regular expression in the data repository;
the computer system receiving another instruction to create another log parser based on another sample log;
the computer system receiving the other sample log;
based on the stored new regular expression and the received other sample log, the computer system identifying a match between another string included in the received other sample log and the stored new regular expression; and
based on the identified match and based on the new regular expression being included in the generated log parser, the computer system generating the other log parser as including the new regular expression that matches the other string included in the other sample log, without requiring another user input of the new regular expression.

11. A computer program product comprising:
a computer-readable, tangible storage device; and
computer-readable program instructions stored in the computer-readable, tangible storage device, the computer-readable program instructions, when carried out by a central processing unit (CPU) of a computer system, implement a method of generating a log parser, the method comprising the steps of:
the computer system receiving regular expressions and storing the regular expressions in a crowd-sourced data repository;
subsequent to receiving and storing the regular expressions, the computer system receiving an instruction to create a log parser based on a sample log;
the computer system receiving the sample log;
based on the stored regular expressions and the received sample log, the computer system identifying matches between a plurality of strings of characters included in the received sample log and a plurality of regular expressions included in the stored regular expressions, each match indicating a regular expression included in the plurality of regular expressions is capable of parsing a respective string included in the plurality of strings; and
based on the identified matches, the computer system generating the log parser as including the plurality of regular expressions that match the plurality of strings included in the sample log.

12. The computer program product of claim 11, wherein the method further comprises the steps of:
the computer system querying the data repository to attempt to identify one or more regular expressions in the data repository capable of parsing one string included in the sample log;
in response to the step of querying the data repository, the computer system determining no regular expression in the data repository is capable of parsing the one string included in the sample log; and
subsequent to the step of determining no regular expression in the data repository is capable of parsing the one string included in the sample log, the computer system receiving a user input of a new regular expression capable of parsing the one string included in the sample log, wherein the step of generating the log parser includes the step of generating the log parser as further including the new regular expression.

13. The computer program product of claim 12, wherein the method further comprises the steps of:
the computer system storing the new regular expression in the data repository;
the computer system receiving another instruction to create another log parser based on another sample log;
the computer system receiving the other sample log;
based on the stored new regular expression and the received other sample log, the computer system identifying a match between another string included in the received other sample log and the stored new regular expression; and
based on the identified match and based on the new regular expression being included in the generated log parser, the computer system generating the other log parser as including the new regular expression that matches the other string included in the other sample log, without requiring another user input of the new regular expression.

14. The computer program product of claim 11, wherein the method further comprises the steps of:
the computer system querying the data repository;
in response to the step of querying the data repository, the computer system identifying one regular expression in the data repository that potentially matches one string included in the sample log;
the computer system presenting a suggestion to use the identified one regular expression to parse the one string included in the sample log;
in response to the step of presenting the suggestion, the computer system receiving a first user input rejecting the suggestion;
subsequent to the step of receiving the first user input rejecting the suggestion, the computer system receiving a second user input of a new regular expression capable of parsing the one string included in the sample log, wherein the step of generating the log parser includes the step of generating the log parser as further including the new regular expression.

15. The computer program product of claim 14, wherein the method further comprises the steps of:
the computer system storing the new regular expression in the data repository;
the computer system receiving another instruction to create another log parser based on another sample log;
the computer system receiving the other sample log;
based on the stored new regular expression and the received other sample log, the computer system identifying a match between another string included in the received other sample log and the stored new regular expression; and
based on the identified match and based on the new regular expression being included in the generated log parser, the computer system generating the other log parser as including the new regular expression that matches the other string included in the other sample log, without requiring another user input of the new regular expression.

16. A process for supporting computing infrastructure, the process comprising:
a first computer system providing at least one support service for at least one of creating, integrating, hosting, maintaining, and deploying computer-readable code in a second computer system, the computer-readable code containing instructions, wherein the instructions, when carried out by a processor of the second computer system, implement a method of generating a log parser, the method comprising the steps of:
the second computer system receiving regular expressions and storing the regular expressions in a crowd-sourced data repository;
subsequent to receiving and storing the regular expressions, the second computer system receiving an instruction to create a log parser based on a sample log;
the second computer system receiving the sample log;
based on the stored regular expressions and the received sample log, the second computer system identifying matches between a plurality of strings of characters included in the received sample log and a plurality of regular expressions included in the stored regular expressions, each match indicating a regular expression included in the plurality of regular expressions is capable of parsing a respective string included in the plurality of strings; and
based on the identified matches, the second computer system generating the log parser as including the plurality of regular expressions that match the plurality of strings included in the sample log.

17. The process of claim 16, wherein the method further comprises the steps of:
the second computer system querying the data repository to attempt to identify one or more regular expressions in the data repository capable of parsing one string included in the sample log;
in response to the step of querying the data repository, the second computer system determining no regular expression in the data repository is capable of parsing the one string included in the sample log; and
subsequent to the step of determining no regular expression in the data repository is capable of parsing the one string included in the sample log, the second computer system receiving a user input of a new regular expression capable of parsing the one string included in the sample log, wherein the step of generating the log parser includes the step of generating the log parser as further including the new regular expression.

18. The process of claim 17, wherein the method further comprises the steps of:
the second computer system storing the new regular expression in the data repository;
the second computer system receiving another instruction to create another log parser based on another sample log;
the second computer system receiving the other sample log;
based on the stored new regular expression and the received other sample log, the second computer system identifying a match between another string included in the received other sample log and the stored new regular expression; and
based on the identified match and based on the new regular expression being included in the generated log parser, the second computer system generating the other log parser as including the new regular expression that matches the other string included in the other sample log, without requiring another user input of the new regular expression.

19. The process of claim 16, wherein the method further comprises the steps of:
the second computer system querying the data repository;
in response to the step of querying the data repository, the second computer system identifying one regular expression in the data repository that potentially matches one string included in the sample log;
the second computer system presenting a suggestion to use the identified one regular expression to parse the one string included in the sample log;
in response to the step of presenting the suggestion, the second computer system receiving a first user input rejecting the suggestion;
subsequent to the step of receiving the first user input rejecting the suggestion, the second computer system receiving a second user input of a new regular expression capable of parsing the one string included in the sample log, wherein the step of generating the log parser includes the step of generating the log parser as further including the new regular expression.

20. The process of claim 19, wherein the method further comprises the steps of:
the second computer system storing the new regular expression in the data repository;
the second computer system receiving another instruction to create another log parser based on another sample log;
the second computer system receiving the other sample log;
based on the stored new regular expression and the received other sample log, the second computer system identifying a match between another string included in the received other sample log and the stored new regular expression; and
based on the identified match and based on the new regular expression being included in the generated log parser, the second computer system generating the other log parser as including the new regular expression that matches the other string included in the other sample log, without requiring another user input of the new regular expression.
